(19) United States
(12) Patent Application Publication
(10) Pub. No.: US 2026/0148242 A1
(43) Pub. Date: May 28, 2026

(54) AI CHATBOT CO-BROWSING

(71) Applicant: Bank of America Corporation, Charlotte, NC (US)

(72) Inventors: Nipun Mahajan, Lawrenceville, NJ (US); Amit Mishra, Chennai (IN); Mohammed Zubair M, Tamil Nadu (IN); S.B. Pravin Kumar, Tamil Nadu (IN)

(21) Appl. No.: 18/962,898

(22) Filed: Nov. 27, 2024

(51) Int. Cl. G06Q 30/016; G06F 3/14; H04L 51/02

(52) U.S. Cl. CPC G06Q 30/015; G06F 3/1454; H04L 51/02

(57) ABSTRACT

Apparatus and methods for providing a co-browsing session between an artificial intelligence (“AI”)-equipped customer assistance digital robot (“bot”) and a user of an enterprise information system portal. The methods may include receiving, by the bot, on a first channel that is accessible by the user from the portal, from the user, performing an operation on a working web page. The working web page may be accessible by the user via the portal from a second channel. The second channel may be accessible by the user from the portal. The second channel may be different from the first channel. The second channel may be in communication with a user-activity monitor. The user-activity monitor may be configured to collect and serve user-activity data. The bot may be a bot that does not have permission to access the user-activity monitor.

### FIELD OF TECHNOLOGY

Aspects of the disclosure relate to providing a co-browsing session between a system user and a machine-based digital robot.

### BACKGROUND

AI robotic bots typically direct users to an information channel into which the bot lacks visibility. The user is expected to complete a task in the channel, but the bot is unable to supervise the user's actions in the channel. The bot may therefore lose control of the user assistance process and cannot provide continuing real time support to the user for completion of the task.

It would be desirable, therefore, to provide apparatus and methods for providing a bot with information about the user's actions in the unsupervised channel in real time.

### SUMMARY

Apparatus and methods for providing a bot with information about the user's actions in the unsupervised channel in real time are provided.

The apparatus and methods may provide a co-browsing session between an artificial intelligence (“AI”)-equipped customer assistance digital robot (“bot”) and a user of an enterprise information system portal.

The methods may include receiving, by the bot, on a first channel that is accessible by the user from the portal, from the user, performing an operation on a working web page, a request for assistance. The working web page may be accessible by the user via the portal from a second channel.

The second channel may be accessible by the user from the portal. The second channel may be different from the first channel. The second channel may be in communication with a user-activity monitor. The user-activity monitor may be configured to collect and serve user-activity data. The bot may be a bot that does not have permission to access the user-activity monitor.

The methods may include detecting an intent of the request. The intent of the request may be referred to herein as the “request intent.” User intent inferred from on-screen user behavior may be referred to herein as “apparent intent.” The methods may include capturing a video stream that includes images. The images may be from a screen-sharing session with the user. The images may be generated in the second channel.

The methods may include defining frames based on the stream. The methods may include deriving a tile for each of the frames. The methods may include identifying in the tile an element of a user interface. The methods may include capturing from the frames a user action.

The methods may include forming from the element and the user action a screen activity context. The methods may include validating the screen activity context against the request intent.

The methods may include formulating assistive information. The assistive information may correspond to the request intent. The assistive information may correspond to the screen activity context.

The methods may include creating code. The code may be configured to graphically display the assistive information to the user within the screen-sharing session. The code may correspond to an overlay of the assistive information over the working web page.

The apparatus may include apparatus for providing a co-browsing session between an artificial intelligence (“AI”)-equipped customer assistance digital robot (“bot”) and a user of an enterprise information system portal.

The apparatus may include a robotic user assistance system.

The robotic user assistance system may be configured to communicate with a user that is in communication with an on-line user access system; and an information services system user that is configured to provide a screen-sharing session with the user.

The robotic user assistance system may be configured to receive on a first channel, from the user, a request for assistance performing an operation on a working web page that is accessible by the user via the portal from a second channel.

The second channel may be different from the first channel. The second channel may be in communication with a user-activity monitor that is configured to collect and serve user-activity data that the robotic user assistance system does not have permission to view.

The robotic user assistance system may be configured to detect an intent of the request. The robotic user assistance system may be configured to capture a video stream that includes images. The images may be from the screen-sharing session with the user. The images may be generated in the second channel.

The robotic user assistance system may be configured to define frames based on the stream. The robotic user assistance system may be configured to derive a tile for each of the frames. The robotic user assistance system may be configured to identify in the tile an element of a user interface. The robotic user assistance system may be configured to capture from the frames a user action. The robotic user assistance system may be configured to form from the element and the user action a screen activity context. The robotic user assistance system may be configured to validate the screen activity context against the intent. The robotic user assistance system may be configured to formulate assistive information.

The assistive information may correspond to the intent. The assistive information may correspond to the screen activity context.

The robotic user assistance system may be configured to create code. The code may be configured to graphically display the assistive information to the user within the screen-sharing session.

The robotic user assistance system may be configured to identify in the frames coordinates of a spatial coordinate schema at which to display the assistive information in a window in which the user operates during the screen-sharing.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative architecture in accordance with the principles of the invention.

FIG. 2 shows an illustrative view of information in accordance with the principles of the invention.

FIG. 3 shows an illustrative view of information in accordance with the principles of the invention.

FIG. 4 shows an illustrative view of information in accordance with the principles of the invention.

FIG. 5 shows an illustrative view of information in accordance with the principles of the invention.

FIG. 6 shows an illustrative view of information in accordance with the principles of the invention.

FIG. 7 shows an illustrative view of information in accordance with the principles of the invention.

FIG. 8 shows an illustrative view of information in accordance with the principles of the invention.

FIG. 9 shows illustrative information in accordance with the principles of the invention.

FIG. 10 shows illustrative information in accordance with the principles of the invention.

FIG. 11 shows an illustrative view of information in accordance with the principles of the invention.

FIG. 12 shows an illustrative view of information in accordance with the principles of the invention.

FIG. 13 shows an illustrative view of information in accordance with the principles of the invention.

FIG. 14 shows an illustrative view of information in accordance with the principles of the invention.

FIG. 15 shows an illustrative view of information in accordance with the principles of the invention.

FIG. 16 shows an illustrative view of information in accordance with the principles of the invention.

FIG. 17 shows an illustrative view of information in accordance with the principles of the invention.

FIG. 18 shows an illustrative view of information in accordance with the principles of the invention.

FIG. 19 shows an illustrative view of information in accordance with the principles of the invention.

FIG. 20 shows illustrative apparatus that may be used in accordance with the principles of the invention.

FIG. 21 shows illustrative apparatus that may be used in accordance with the principles of the invention.

FIG. 22 shows illustrative architecture in accordance with the principles of the invention.

FIG. 23 shows an illustrative architecture in accordance with the principles of the invention.

FIG. 24 shows illustrative steps in accordance with the principles of the invention.

FIG. 25 shows illustrative steps in accordance with the principles of the invention.

The leftmost digit (e.g., “L”) of a three-digit reference numeral (e.g., “LRR”), and the two leftmost digits (e.g., “LL”) of a four-digit reference numeral (e.g., “LLRR”), generally identify the initial figure in which a part is called-out.

### DETAILED DESCRIPTION

Apparatus and methods for providing a co-browsing session between an artificial intelligence (“AI”)-equipped customer assistance digital robot (“bot”) and a user of an enterprise information system portal are provided.

Steps of the method may be performed by the bot. Steps of the method may be performed by apparatus, firmware or hardware that acts in support of or under instructions from the bot.

The methods may include receiving, by the bot, on a first channel that is accessible by the user from the portal, from the user, performing an operation on a working web page, a request for assistance. The working web page may be accessible by the user via the portal from a second channel.

The second channel may be accessible by the user from the portal. The second channel may be different from the first channel. The second channel may be in communication with a user-activity monitor. The user-activity monitor may be configured to collect and serve user-activity data. The bot may be a bot that does not have permission to access the user-activity monitor.

The methods may include detecting an intent of the request. The intent of the request may be referred to herein as the “request intent.” User intent inferred from on-screen user behavior may be referred to herein as “apparent intent.” The methods may include capturing a video stream that includes images. The images may be from a screen-sharing session with the user. The images may be generated in the second channel.

The methods may include defining frames based on the stream.

The methods may include deriving a tile for each of the frames.

The methods may include identifying in the tile an element of a user interface.

The methods may include capturing from the frames a user action.

The methods may include forming from the element and the user action a screen activity context.

The methods may include validating the screen activity context against the request intent.

The methods may include formulating assistive information. The assistive information may correspond to the request intent. The assistive information may correspond to the screen activity context.

The methods may include creating code. The code may be configured to graphically display the assistive information to the user within the screen-sharing session. The code may correspond to an overlay of the assistive information over the working web page.

The identifying in the tile may include matching the element to elements that are known to be included in the second channel.

The identifying in the tile may include matching the element to elements that are known to be accessed via the second channel.

The user action may correspond to a cursor position, a cursor motion, a mouse click, a keyboard entry, a quiescence or any other suitable user action.

The assistive information may include a directive. The directive may include an instruction by the bot to perform one or more user actions or combinations of user actions. The directive may include a format. The format may include a static layout. The layout may include text, a pointer, a highlighting, a photograph, a screen shot, a cartoon, a view of a web page or any other suitable layout.

The format may include an animation. The animation may be an animation of one or more static layouts.

The format may include an interactive control. The interactive control may include one or more of a text box, a hypertext link, a drop-down list, a static layout, an animation or any other suitable interactive control. The interactive control may include a user input feature that may capture a user action. The bot may provide a response to the user action. The response may include assistive information.

The frames may include a spatial coordinate schema that corresponds to the frame and a window in which the user operates during the screen-sharing, identifying coordinates of the spatial coordinate schema at which to display the assistive information.

The spatial coordinate system may be referenced to a point in a frame. The spatial coordinate system may be referenced to a point in the tile.

The validating may include determining whether the user action is consistent with the request intent.

The coordinates may correspond to a current user cursor position. The coordinates may correspond to a cursor position that is consistent with the request intent.

The element may be a first element. The validating may be configured to determine that a second element better matches the request intent than does the first element.

The coordinates may correspond to an assistive user cursor position. The assistive user cursor position may correspond to the second element.

The coordinates may correspond to a position of a tile relative to a frame.

The assistive information include markup language that is designated for the second element. The assistive information include coordinates corresponding to the second element.

The user action may correspond to first content. The validating may be configured to determine that second content better matches the request intent than does the first content.

The assistive information may include markup language that is configured to display the second content. The assistive information may include coordinates that correspond to the element.

The coordinates may correspond to a current user cursor position.

The methods may include detecting that the user has provided first keyboard input into an input field, the first keyboard input corresponding to a first category of information, and the input field corresponding to a second category of information that is different from the first category of information. The assistive information may be configured to: receive from the user second keyboard input that corresponds to the second category; and populate the input field with the second keyboard input.

The apparatus may include apparatus for providing a co-browsing session between an artificial intelligence (“AI”)-equipped customer assistance digital robot (“bot”) and a user of an enterprise information system portal.

The apparatus may include a robotic user assistance system.

The robotic user assistance system may be configured to communicate with a user that is in communication with an on-line user access system; and an information services system user that is configured to provide a screen-sharing session with the user.

The robotic user assistance system may be configured to receive on a first channel, from the user, a request for assistance performing an operation on a working web page that is accessible by the user via the portal from a second channel.

The second channel may be different from the first channel. The second channel may be in communication with a user-activity monitor that is configured to collect and serve user-activity data that the robotic user assistance system does not have permission to view.

The robotic user assistance system may be configured to detect an intent of the request. The robotic user assistance system may be configured to capture a video stream that includes images. The images may be from the screen-sharing session with the user. The images may be generated in the second channel.

The robotic user assistance system may be configured to define frames based on the stream. The robotic user assistance system may be configured to derive a tile for each of the frames. The robotic user assistance system may be configured to identify in the tile an element of a user interface. The robotic user assistance system may be configured to capture from the frames a user action. The robotic user assistance system may be configured to form from the element and the user action a screen activity context. The robotic user assistance system may be configured to validate the screen activity context against the intent. The robotic user assistance system may be configured to formulate assistive information.

The assistive information may correspond to the intent. The assistive information may correspond to the screen activity context.

The robotic user assistance system may be configured to create code. The code may be configured to graphically display the assistive information to the user within the screen-sharing session.

The robotic user assistance system may be configured to identify in the frames coordinates of a spatial coordinate schema at which to display the assistive information in a window in which the user operates during the screen-sharing.

The robotic user assistance system may be configured to determine that the user action is consistent with the intent.

The coordinates may correspond to a current user cursor position.

The robotic user assistance system may be configured to determine that the user action is not consistent with the intent.

The element may be a first element. The robotic user assistance system may be configured to determine that a second element better matches the intent than does the first element.

The coordinates may correspond to an assistive user cursor position.

The assistive information may include markup language that is designated for the second element. The assistive information may include coordinates corresponding to the second element.

The user action may correspond to first content. The robotic user assistance system may be configured to determine that a second content better matches the intent than does the first content.

The assistive information may include markup language that is configured to display the second content. The assistive information may include coordinates that correspond to the element.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

The apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

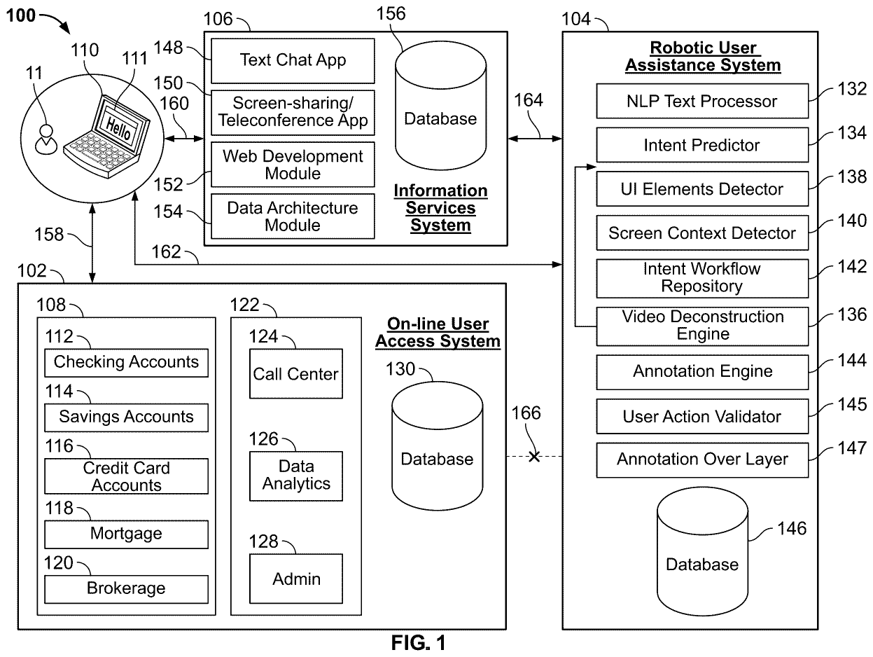

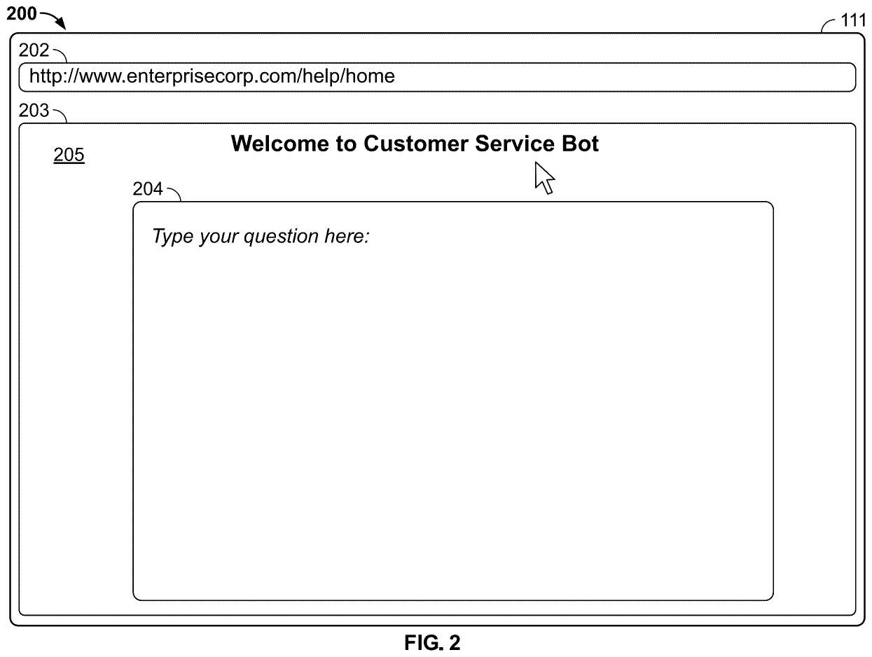

FIG. 1 shows illustrative architecture 100 for providing robotic co-browsing with user U. The robotic co-browsing may be controlled by an enterprise. Architecture 100 may include enterprise on-line user access system 102. Architecture 100 may include enterprise robotic user-assistance system 104. Enterprise robotic user-assistance system 104 may be or may include an AI-assisted “bot.” Architecture 100 may include enterprise information services system 106.

Systems 102, 104 and 106 may be used cooperatively to provide assistance to user U. One or more of systems 102, 104 and 106 may have access to one or more of the other systems. One or more of systems 102, 104 and 106 may be without access to one or more of the other systems. Access may be based on physical communication. Access may be based on credentials, permission or the like. Access may be based on compatibility, between the systems, of data structures, data formats, programming languages, protocols or other suitable categories of compatibility.

On-line user access system 102 may include front end 108. Front end 108 may provide a portal that is accessible by user U using user machine 110. The portal may provide to user U a user interface. The interface may be displayed in window 111 on machine 110. User U may access web pages corresponding to one or more accounts that are hosted by front-end 104. The web pages may include web pages 112 for checking accounts, 114 for savings accounts, 116 for credit card accounts, 118 for mortgage accounts, 120 for brokerage accounts, and any other suitable web pages.

On-line user access system 102 may include back end 122. Back end 122 may provide a portal that is accessible to one or more sub-enterprise entities. The portal may provide data about user actions performed by users such as user U during interactions with web pages provided by front end 108. Sub-enterprise entities such as call center 124, data analytics 126 and admin 128 may have access to the user action data. The user action data may be stored in database 130.

Robotic user-assistance system 104 may provide assistance to user U in connection with activities that user U may undertake while engaged with on-line user access system 102. Robotic user-assistance system 104 may include functional units such as natural language processing (“NLP”) unit 132, AI-based intent predictor 134, video deconstruction engine 136, UI Elements Detector 138, screen context model 140, intent workflow repository 142, annotation engine 144, database 146 and any other suitable components.

Video deconstruction engine 136 may include one or more of a frame-capturing converter (not shown), a cursor/keyboard detector (not shown), a tile segmenting converter (not shown) and a user interface (“UI”) elements detector (not shown).

Natural language processing (“NLP”) unit 132 may provide 2-way coding and decoding of text for communication by text with user U. AI-based intent predictor 134 may determine an intent (a “request intent”) of user U based on text provided by user U to robotic user-assistance system 104. UI Elements Detector 136 may interact with a library of user interface elements that are in use in front end 108, screen context model 140 may provide an apparent intent of user U based on user actions of user U when user U is engaged with front end 108. Intent workflow repository 140 may provide a historical library of user intents against which the apparent intent can be validated. Video deconstruction engine 142 may break streaming video down to frames and tiles for derivation of the apparent intent. Annotation engine 144 may generate assistive information that robotic user-assistance system may provide to user U via a screen-sharing overlay. Database 146 may be a data repository for the computational processes and data of robotic user-assistance system 104.

Information services system 106 may provide information services to the enterprise. The information services may include services such as text chat app 148, screen-sharing/teleconference app 150, web development module 152, data architecture module 154 and other suitable information services. Information services system 106 may include database 156. Database 156 may be a data repository for the processes and data of information services system 106.

Architecture 100 may include channel 158. Architecture 100 may include channel 160. Architecture 100 may include channel 162.

A channel may include a communication channel that conforms to one or more of the HTTP, WebSocket, gRPC, and WebRTC protocols or the like. A channel may have one or more access requirements.

Channel 158 may provide communication between user U and on-line user access system 102. Channel 160 may provide communication between user U and information services system 106. Channel 162 may provide communication between user U and robotic user assistance system 104. Channel 164 may provide communication between information services system 106 and robotic user assistance system 104. Channel 164 may thus provide for communication between user U and robotic user assistance system 104.

Relationship 166 between on-line user access system 102 and robotic user assistance system 104 may be a relationship in which robotic user assistance system does not have access to on-line user access system 102. The lack of access may be a lack of access to some or all of the resources (e.g., web pages, directories, uniform resource locators (“URL”), domains, sub-domains and the like) of on-line user access system 102. The lack of access may be based on an absence of a channel. The lack of access may be based on an absence of a physical communication medium. The lack of access may be based on an absence of credentials, permission or the like. The lack of access may be based on a lack of compatibility, between the systems, of data structures, data formats, programming languages, protocols or other categories of compatibility.

Architecture 100 may allow robotic user-assistance system 104 to view the portal as displayed in window 111 on user U machine 110 via screen-sharing/teleconference app 150.

FIG. 2 shows view 200 of user U window 111. URL 202 may correspond to channel 160. URL 202 may correspond to channel 162. User U may have been directed to URL 202 by on-line user access system 102. Window 111 may display web page 203. Web page 203 may include content 205. User U may use dialog box 204 in window 111 to type a query and send it to robotic user-assistance system 104.

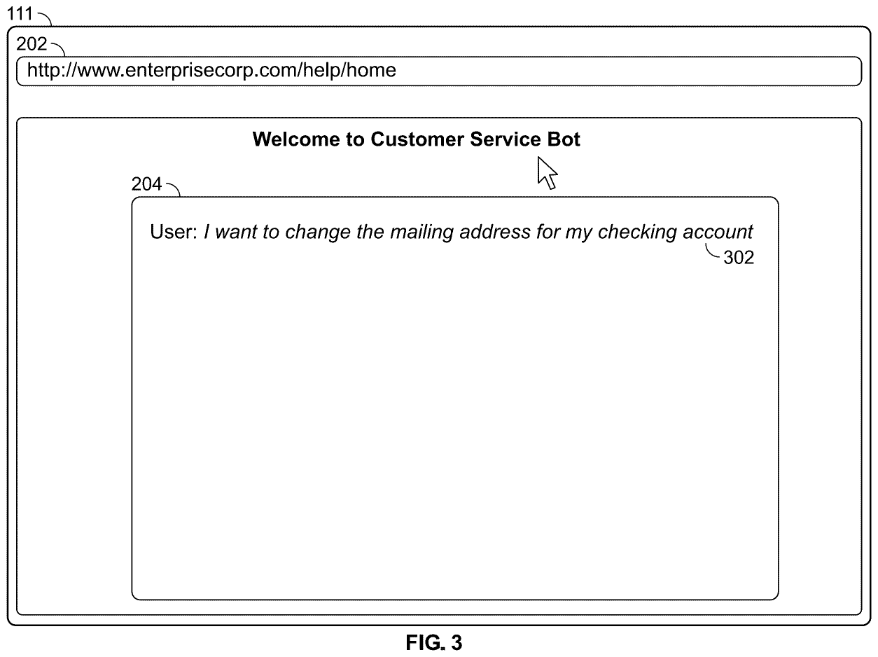

FIG. 3 shows text 302 that may have been entered into dialog box 202 by user U. Text 302 requests assistance changing a mailing address associated with a check account of user U.

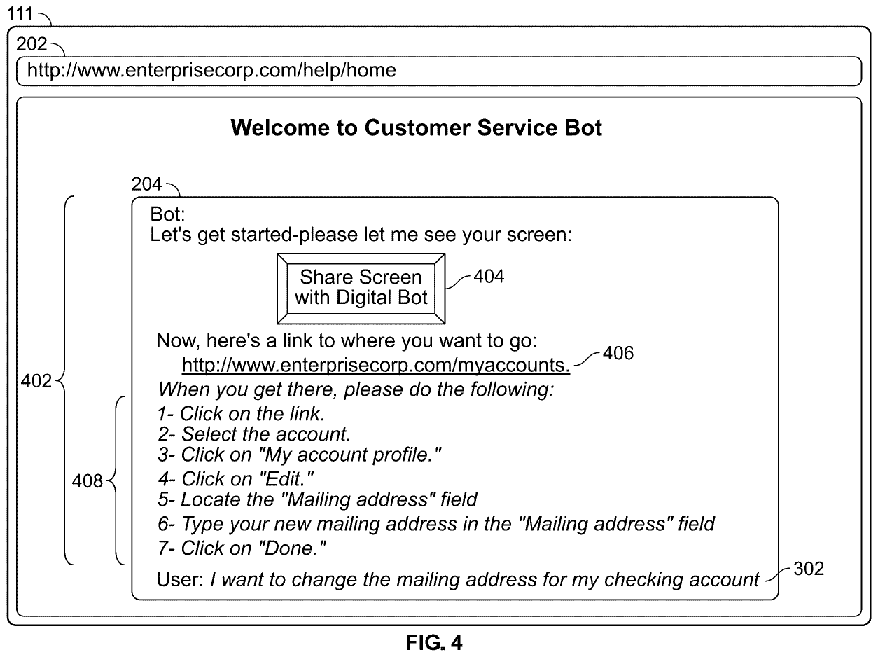

FIG. 4 shows content box 402, in dialog box 204, that may have been provided by robotic user-assistance system 104 in response to text 302 of user U. Content box 402 may include button 404. Button 404 may link to executable code that establishes a screen-sharing session, via information services system 106, between machine 110 and robotic user assistance system 104.

Content box 402 may include hyperlink 406, which points to a URL for “My Accounts,” which may correspond to front end 108 of on-line user access system 102. Text 402 may include instructions 408, which are to be carried out in front end 108, to which robotic user assistance system 104 does not have access. Robotic user assistance system 104 therefore cannot monitor user U user actions, for example, using back end 122 or database 130. Robotic user assistance system 104 may view window 111, or some or all of the screen of machine 110, via the screen-sharing session.

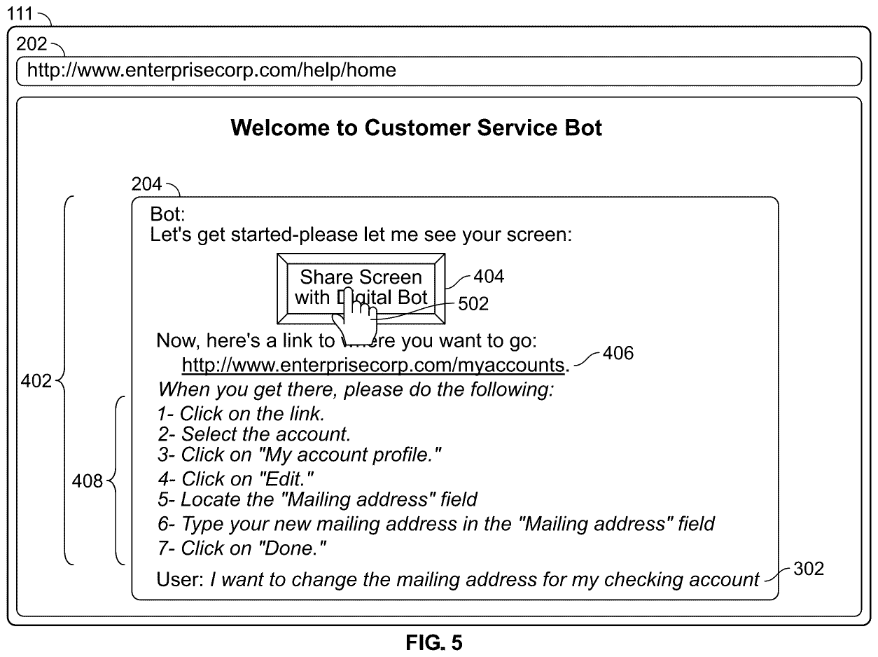

FIG. 5 shows user U using cursor 502 to click on hyperlink 404.

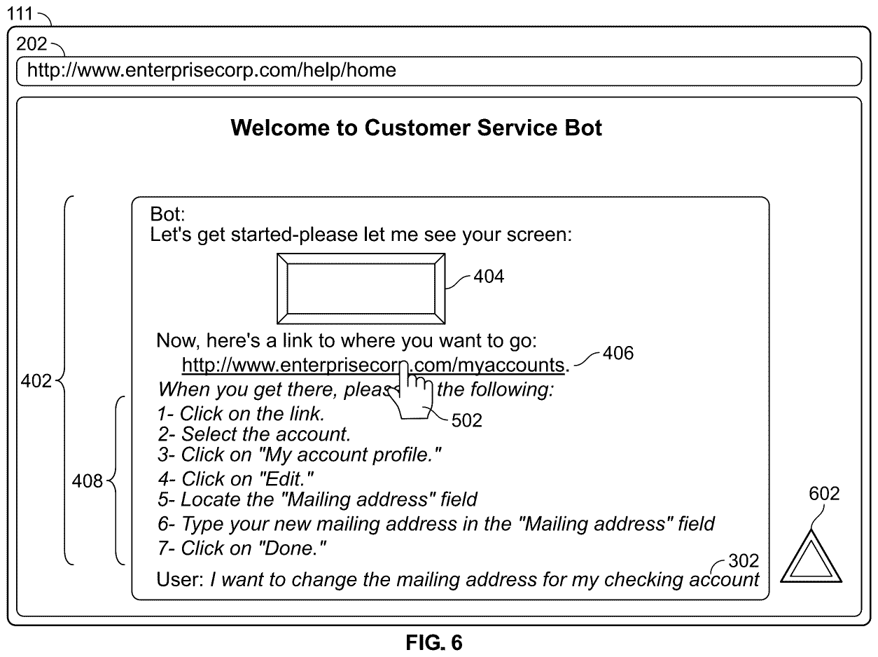

FIG. 6 shows that user U has initiated the screen-sharing session. Button 404 may be grayed-out to indicate that it already has been activated. Window 111 may display an item such as symbol 602 to indicate that the screen-sharing session is in operation. Window 111 may display an avatar (not shown) that represents the bot. The avatar may be animated. Window 111 may include a pane in which it displays the avatar.

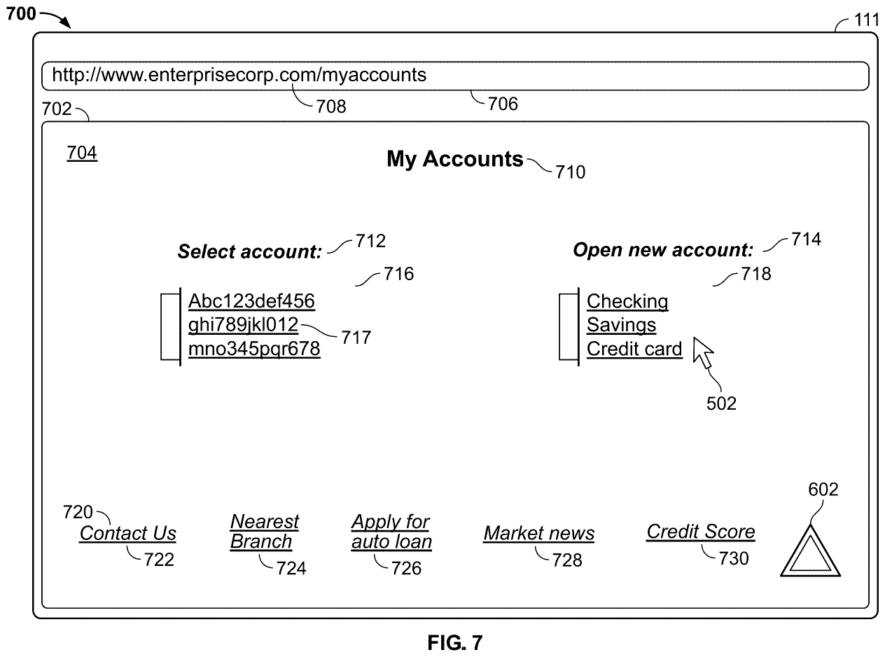

FIG. 7 shows view 700 of window 111. View 700 shows that user U has navigated to web page 702. Web page 702 may include content 704. Window 111 may display browser URL field 706. URL 708 may be displayed in URL field 706. URL 708 may be different from URL 202. Robotic user-assistance system 104 may be unable to access content at URL 708. URL 202 may accessible via a first channel. URL 708 may be accessible via a second channel. URL 708 may be accessible only via the second channel. URL 708 may be accessible via the second channel and not the first channel.

Content 704 may include page header 710. Content 704 may include vertical link list header 712. Content 704 may include vertical link list header 714. Vertical link list header 712 may head up vertical link list 716. Vertical link list header 714 may head up vertical link list 718. Vertical link list 718 may include hyperlink 719 for account ghi789jkl012.

Content 704 may include horizontal link list 720. Horizontal link list 720 may include one or more of links 722, 724, 726, 728 and 730.

Window 702 may display cursor 502.

View 700 may be a rendering of segments of window 702. The segments may include one or more tiles and one or more user interface elements. View 700 may be streamed via screen-sharing/teleconference app 150 to robotic user-assistance system 104.

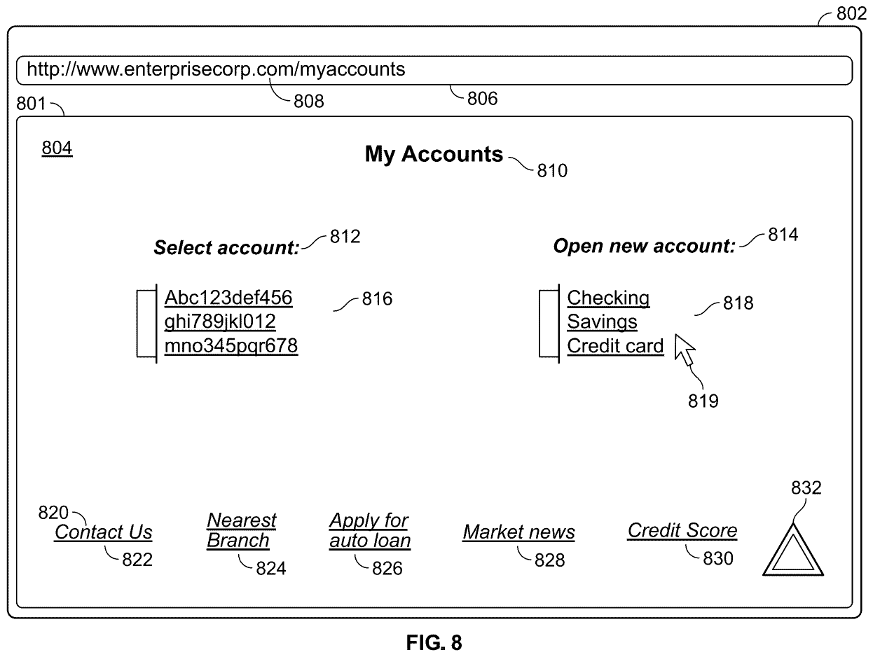

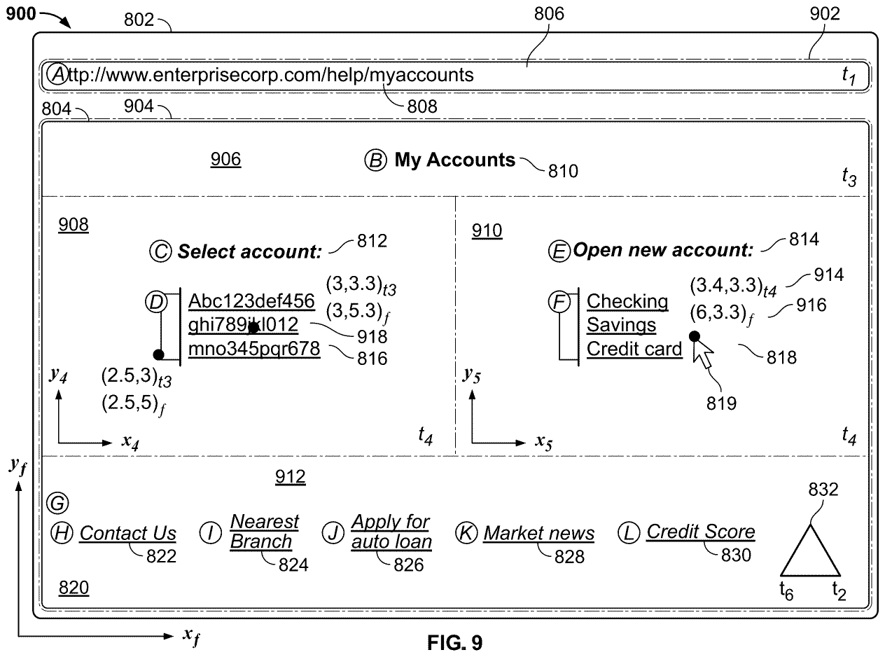

FIG. 8 shows view 800. View 800 may include frame 802. Frame 802 may have been captured by video deconstruction engine 136. Frame 802 may correspond to window 111. Frame 802 may be unsegmented. Frame 802 may be one of a time-series of frames captured from the screen-sharing session. Video deconstruction engine 136 may capture frames at a rate of 1 frame per 10 seconds, 1 frame per second, 2 frames per second, 5 frames per second, or any intermediate rates therein, or any other suitable rates.

Table 1 shows a correspondence between elements of view 800 and segments of view 700.

TABLE 1
A correspondence between unsegmented elements
of view 800 and segments of view 700.
Unsegmented elements of view 800
and segments of view 700

| Unsegmented element of view 800 | Segmented element of view 700 |
|---|---|
| 801 | web page 702 |
| 804 | content 704 |
| 806 | browser url field 706 |
| 808 | URL 708 |
| 810 | page header 710 |
| 812 | vertical link list header 712 |
| 814 | vertical link list header 714 |
| 816 | vertical link list 716 |
| 818 | vertical link list 718 |
| 819 | cursor 502 |
| 820 | horizontal link list 720 |
| 822 | link 722 |
| 824 | link 724 |
| 826 | link 726 |
| 828 | link 728 |
| 830 | link 730 |
| 832 | symbol 602 |

FIG. 9 shows illustrative segmentation 900 of frame 802. Segmentation 900 may include frame segments. The segments may include tiles. The segments may include UI elements.

Video deconstruction engine 136 may define tiles. The tiles may may include tile 902 (t1), which may correspond to element 806, tile 904 (t2), which may correspond to element 801, tile 906 (t3), which may include element 810, tile 908 (t4), which may include elements 812 and 816, tile 910 (t5), which may include elements 814 and 818, and tile 912 (t6), which may include elements 820, 822, 824, 826, 828, 830 and 832.

Video deconstruction engine 136 may identify UI elements A-L.

Video deconstruction engine 136 may define spatial coordinates (x_{f},y_{f}) for frame 802, (xₜ₄, yₜ₄) for tile t₄ and (xₜ₅, yₜ₅) for tile t₅.

Video deconstruction engine 136 may determine coordinates of some or all of the tiles and UI elements of segmentation 900. For example, video deconstruction engine 136 may determine the coordinates 914 (relative to t4) or 916 (relative to frame 802) of user cursor element 819. Screen context detector 140 may determine that user cursor element 819 is positioned for selection of a savings account in a list of account types for opening a new account. User action validator 145 may determine that the positioning of user cursor element 819 is not consistent with the request intent (of user request 302). User action validator 145 may identify one or more of tile 908 (t4), vertical link list header element 802 (“C”), vertical link list element 816 (“D”), or link element 918 as targets that better align with the request intent.

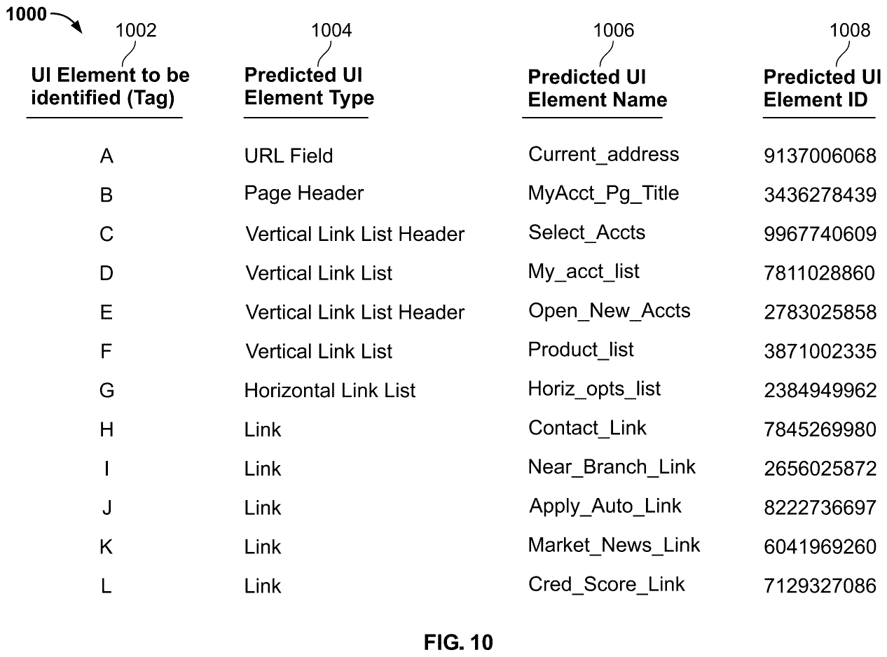

FIG. 10 shows illustrative elements correlation 1000. Correlation 1000 may be generated by UI elements detector 138. Correlation 1000 may list UI Elements 1002 (A-L) to be identified in frame 802, corresponding UI Element Types 1004, Predicted UI Element Names 1006 and Predicted UI Element IDs 1008.

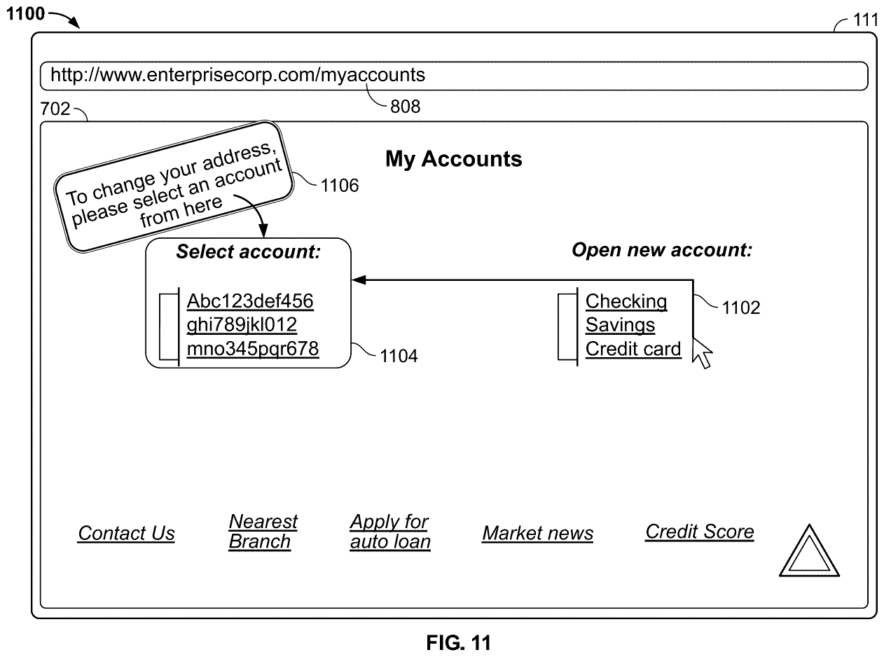

FIG. 11 shows view 1100 of window 111. Annotation engine 144 may formulate one or more elements of assistive information such as trajectory 1102, highlight box 1104 and text box 1106. Annotation overlayer 147 may generate an overlay that positions the assistive information over web page. The assistive information may direct user U to a user element that is more aligned with the request intent.

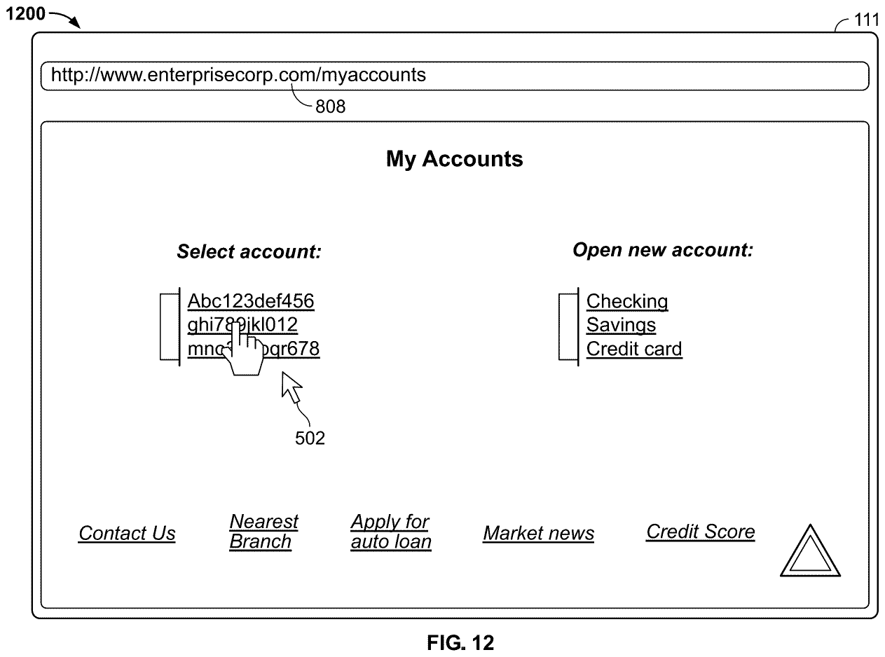

FIG. 12 shows view 1200 of window 111. User U has, in response to the assistive information, moved cursor 502 to a link that is more aligned with the request intent.

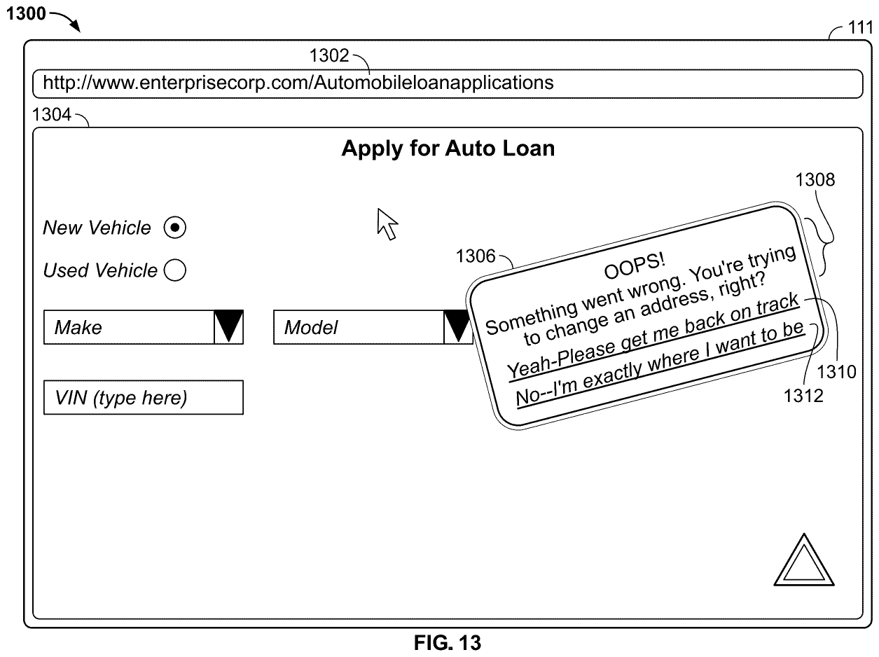

FIG. 13 shows view 1300 of window 111. In view 1300, user U has navigated to URL 1302, which is associated with web page 1304. Screen context detector 140 may determine that web page 1304 is not aligned with the request intent. Annotation engine 144 may generate assistive information 1306. Assistive information 1306 may include text 1308. Assistive information 1306 may include one or more hyperlinks such as 1310 and 1312.

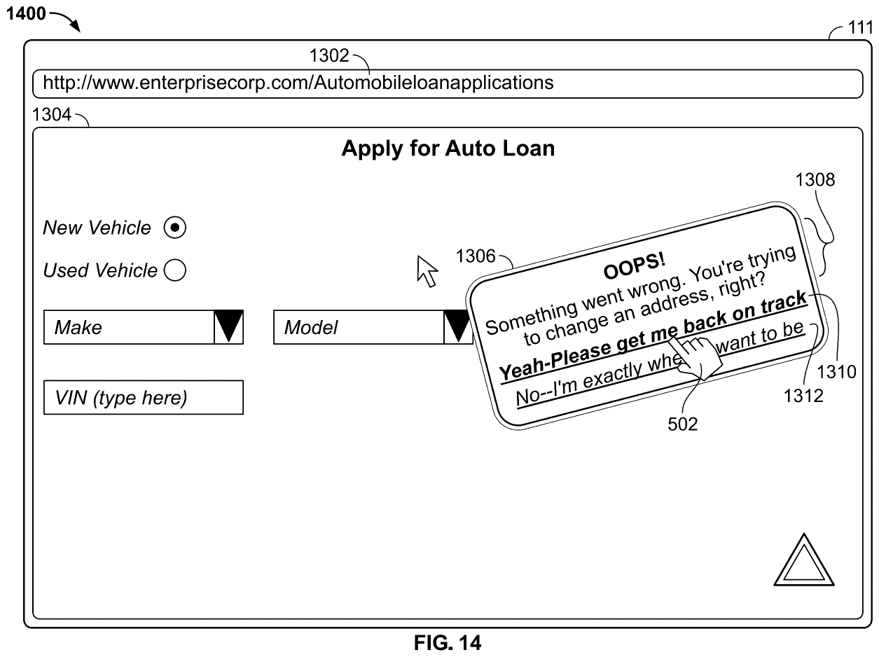

FIG. 14 shows view 1400 of window 111. In view 1400, user U uses cursor 502 to select link 1310 to request help getting back to a web page consistent with the request intent of request 302.

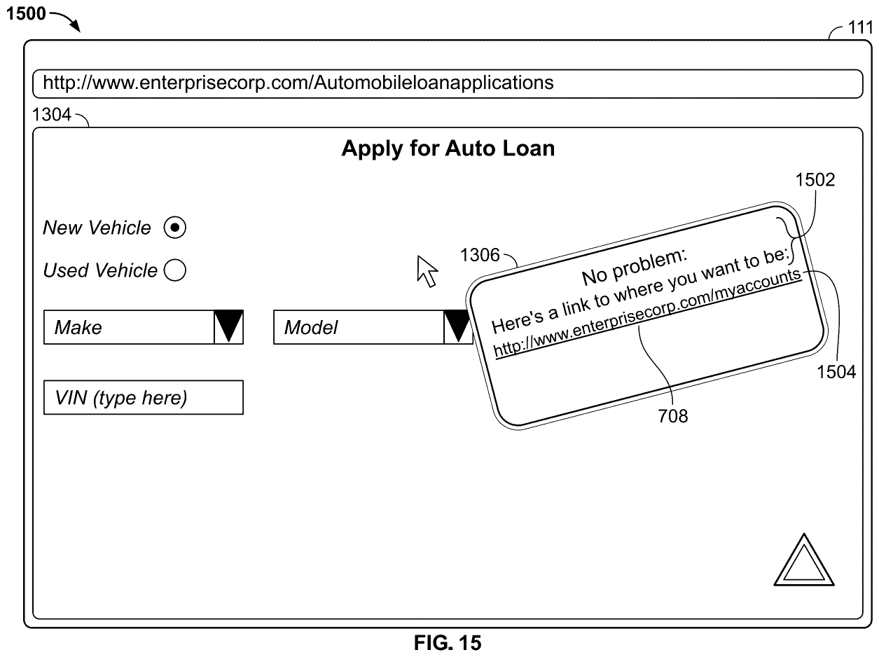

FIG. 15 shows view 1500 of window 111. In view 1500, robotic user-assistance system 104 may provide user U with text 1502 and hyperlink 1504. Hyperlink 1504 may bring user U back to URL 708.

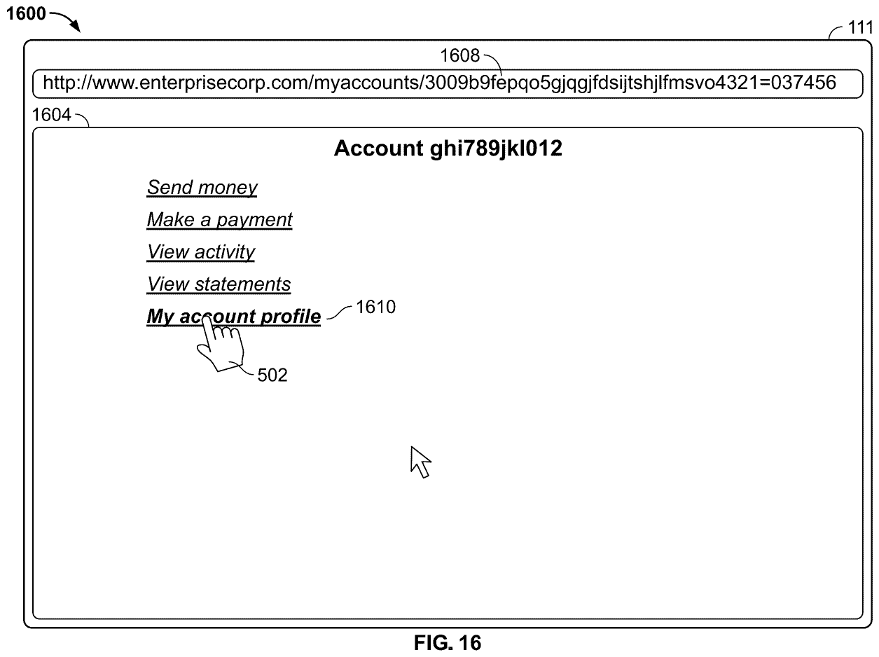

FIG. 16 shows view 1600 of window 111. In view 1600, user U has returned (not shown) to web page 702, corresponding to URL 708. User U has selected (not shown) hyperlink 717, which is associated with account ghi789jkl012, and has arrived at web page 1604 at URL 1608, which corresponds to account ghi789jkl012. User U may click on hyperlink 1610, consistent with instructions 402. User U may then continue to follow instructions 402 to change the address identified in user request 302.

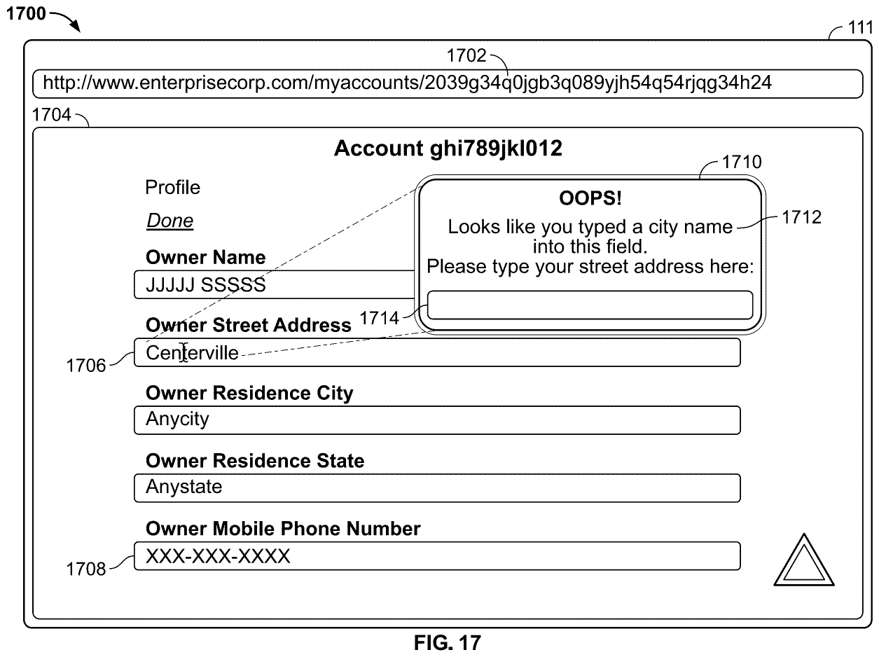

FIG. 17 shows view 1700 of window 111. In view 1700, user U has navigated to web page 1704 at URL 1702 by clicking on hyperlink 1610. Web page 1704 may include field 1706. Field 1706 may be designated for entry of street address information (“Owner Street Address). In field 1706, user U has entered the text “Centerville.” Robotic user assistance system 104 may recognize that “Centerville” corresponds to a city name, not a street address. Robotic user assistance system 104 may recognize that “Centerville” corresponds to an apparent intention that does not match the request intention. Robotic user assistance system 104 may recognize that “Centerville” is in a category of information that does not match a category with which field 1706 is associated.

Robotic user assistance system 104 may in real time provide assistive information 1710. Assistive information 1710 may include text 1712. Assistive information 1710 may include field 1714. Text 1712 may prompt user U to enter street information, which aligns with the request intent.

Similarly, if user U attempted to change data in field 1708, which is associated with a mobile telephone number, even if user U were to enter a legitimate telephone number, robotic user assistance system 104 may recognize that the apparent intention of entering text in field 1708 is inconsistent with the request intention. Robotic user assistance system 104 may then provide assistive information to direct user U to field 1706.

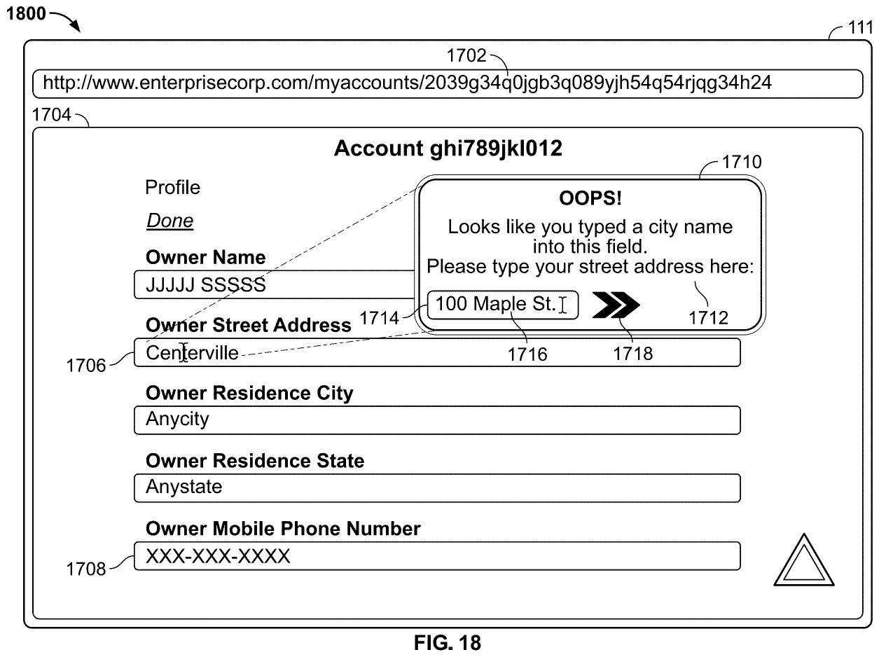

FIG. 18 shows view 1800 of window 111. In view 1800, user U has entered text 1716 into field 1714. Text 1716 includes a street address (“100 Maple St.”). User U's apparent intention now aligns with user U's request intention. User U may submit text 1716 to robotic user assistance system 104 by clicking on send icon 1718.

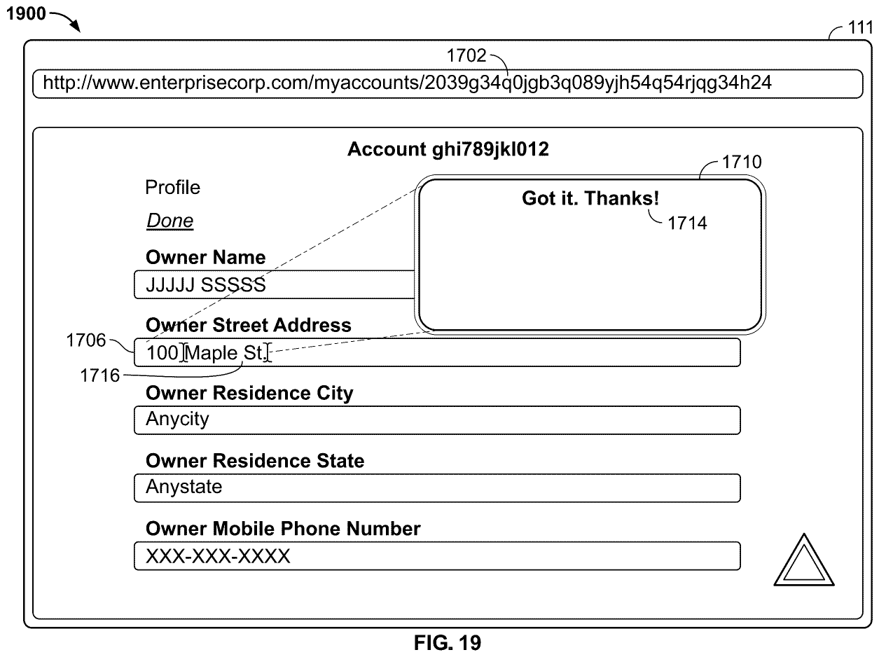

FIG. 19 shows view 1900 of window 111. Robotic user assistance system 104 has provided text 1714 acknowledging the submission of text (“1716”) that conforms to the user intent. Robotic user assistance system 104 may populate field 1706 with text 1716 by providing text 1716 to the browser displaying window 111 via screen-sharing/teleconference app 150. Robotic user assistance system 104 may overlay text 1716 on field 1706. Robotic user assistance system 104 may instruct user U to enter “100 Maple St.” into field 1706 by overtyping the overlay of text 1716 in field 1706.

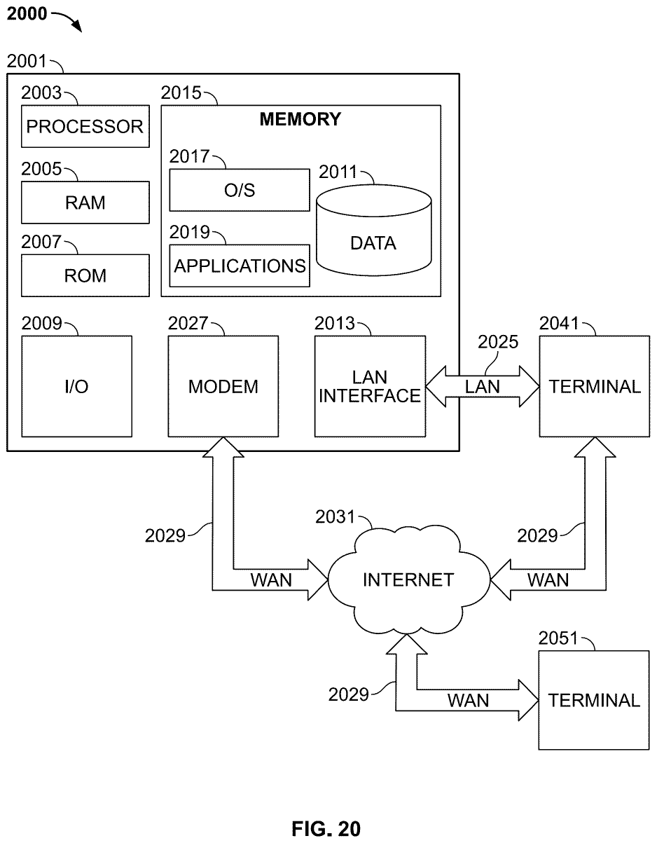

FIG. 20 shows an illustrative block diagram of system 2000 that includes computer 2001. Computer 2001 may alternatively be referred to herein as an “engine,” “server” or a “computing device.” Computer 2001 may be a workstation, desktop, laptop, tablet, smart phone, or any other suitable computing device. Elements of system 2000, including computer 2001, may be used to implement various aspects of the systems and methods disclosed herein. Each of the nodes, servers, computing devices, APIs, display monitors, databases and any other part of the disclosure may include some or all of apparatus included in system 2000.

Computer 2001 may have a processor 2003 for controlling the operation of the device and its associated components and may include Random Access Memory (“RAM”) 2005, Read Only Memory (“ROM”) 2007, input/output circuit 2009 and a non-transitory or non-volatile memory 2015. Machine-readable memory may be configured to store information in machine-readable data structures. The processor 2003 may also execute all software executing on the computer—e.g., the operating system and/or voice recognition software. Other components commonly used for computers, such as EEPROM or Flash memory or any other suitable components, may also be part of the computer 2001.

Memory 2015 may be comprised of any suitable permanent storage technology e.g., a hard drive. Memory 2015 may store software including the operating system 2017 and application(s) 2019 along with any data 2011 needed for the operation of the system 2000. memory 2015 may also store videos, text and/or audio assistance files. nodes, servers, computing devices, APIs, display monitors, databases and any other suitable computing device as disclosed herein may have one or more features in common with memory 2015. The data stored in memory 2015 may also be stored in cache memory, or any other suitable memory.

Input/output (“I/O”) module 2009 may include connectivity to a microphone, keyboard, touch screen, mouse and/or stylus through which input may be provided into computer 2001. The input may include input relating to cursor movement or keyboard input. The input/output module may also include one or more speakers for providing audio output and a video display device for providing textual, audio, audiovisual and/or graphical output. The input and output may be related to computer application functionality.

System 2000 may be connected to other systems via a local area network (“LAN”) interface 2013. System 2000 may operate in a networked environment supporting connections to one or more remote computers, such as terminals 2041 and 2051. Terminals 2041 and 2051 may be personal computers or servers that include many or all of the elements described above relative to system 2000. When used in a LAN networking environment, computer 2001 is connected to LAN 2025 through a LAN interface or adapter 2013. When used in a Wide Area Network (“WAN”) networking environment, computer 2001 may include a modem 2027 or other means for establishing communications over WAN 2029, such as Internet 2031. Connections between System 2000 and Terminals 2051 and/or 2041 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 2019, which may be used by computer 2001, may include computer executable instructions for invoking functionality related to communication, such as e-mail, Short Message Service (“SMS”) and voice input and speech recognition applications. Application program(s) 2019 (which may be alternatively referred to herein as “plugins,” “applications,” or “apps”) may include computer executable instructions for invoking functionality related to performing various tasks. Application programs 2019 may utilize one or more algorithms that process received executable instructions, perform power management routines or other suitable tasks. Application programs 2019 may utilize one or more decisioning processes.

Application program(s) 2019 may include computer executable instructions (alternatively referred to as “programs”). The computer executable instructions may be embodied in hardware or firmware (not shown). Computer 2001 may execute the instructions embodied by the application program(s) 2019 to perform various functions.

Application program(s) 2019 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 2011 and any other suitable information, may be stored in memory 2015. One or more of applications 2019 may include one or more algorithms that may be used to implement features of the disclosure comprising the transmission, storage, and transmitting of data and/or any other tasks described herein.

The invention may be described in the context of computer-executable instructions, such as applications 2019, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 2001 and/or terminals 2041 and 2051 may also include various other components, such as a battery, speaker and/or antennas (not shown). Components of computer system 2001 may be linked by a system bus, wirelessly or by other suitable interconnections. Components of computer system 2001 may be present on one or more circuit boards. In some embodiments, the components may be integrated into a single chip. The chip may be silicon-based.

Terminal 2051 and/or terminal 2041 may be portable devices such as a laptop, cell phone, tablet, smartphone, or any other computing system for receiving, storing, transmitting and/or displaying relevant information. Terminal 2051 and/or terminal 2041 may be one or more data sources or a calling source. Terminals 2051 and 2041 may have one or more features in common with apparatus 2001. Terminals 2015 and 2041 may be identical to system 2000 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

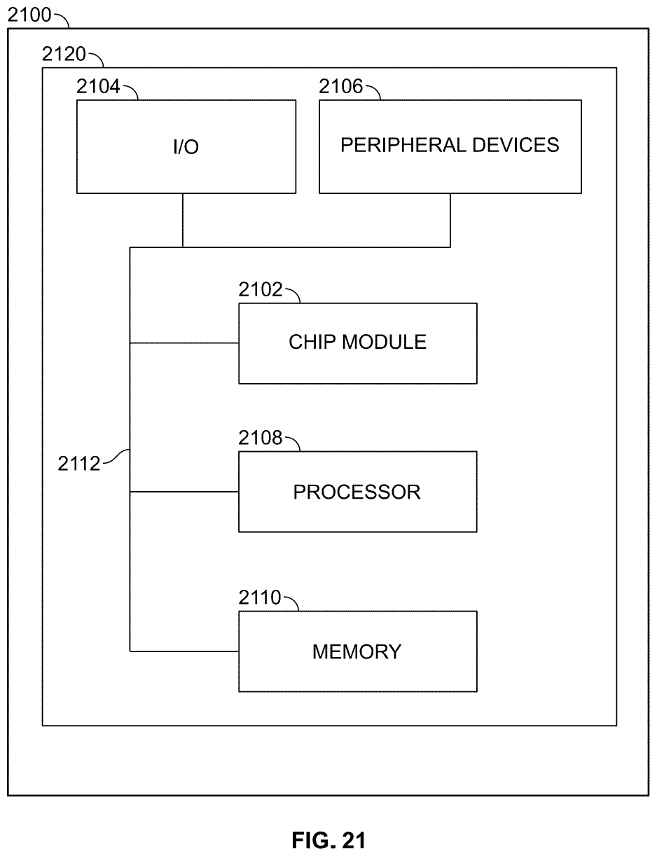

FIG. 21 shows illustrative apparatus 2100 that may be configured in accordance with the principles of the disclosure. Apparatus 2100 may be a computing device. Apparatus 2100 may include one or more features of the apparatus shown in FIG. 2000. Apparatus 2100 may include chip module 2102, which may include one or more integrated circuits, and which may include logic configured to perform any other suitable logical operations.

Apparatus 2100 may include one or more of the following components: I/O circuitry 2104, which may include a transmitter device and a receiver device and may interface with fiber optic cable, coaxial cable, telephone lines, wireless devices, PHY layer hardware, a keypad/display control device or any other suitable media or devices; peripheral devices 2106, which may include counter timers, real-time timers, power-on reset generators or any other suitable peripheral devices; logical processing device 2108, which may compute data structural information and structural parameters of the data; and machine-readable memory 2110.

Machine-readable memory 2110 may be configured to store in machine-readable data structures: machine executable instructions, (which may be alternatively referred to herein as “computer instructions” or “computer code”), applications such as applications 119, signals and/or any other suitable information or data structures.

Components 2102, 2104, 2106, 2108 and 2110 may be coupled together by a system bus or other interconnections 2112 and may be present on one or more circuit boards such as 2120. In some embodiments, the components may be integrated into a single chip. The chip may be silicon-based.

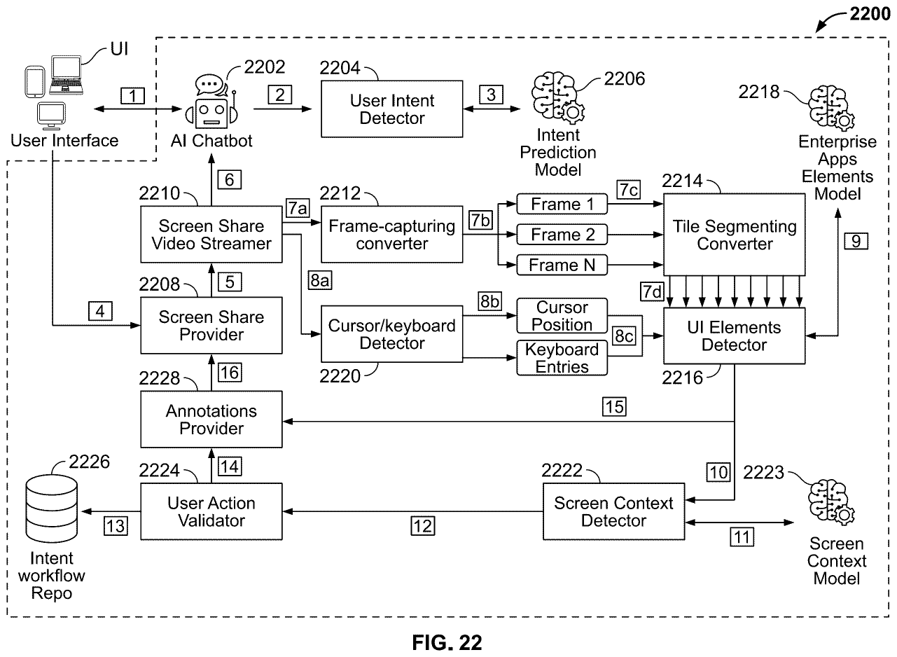

FIG. 22 shows illustrative architecture 2200 for providing co-browsing between a robotic user-assistance system and a user of an on-line user access system to which the robotic user-assistance system does not have access. One or more features of architecture 2200 may correspond to features of information services system 106 and robotic user assistance system 104. Architecture 2200 may include AI chatbot 2202. AI chatbot 2202 may receive a request for assistance from a user interface such as user interface UL. AI chatbot 2202 may submit the request to user intent detector 2204. User intent detector 2204 may be configured to implement natural language programming techniques, in conjunction with intent prediction model 2206, to derive an intent of the request (a “request intent”).

AI chatbot 2202 may provide user interface UI with executable code to initiate a screen-sharing session via screen-sharing provider 2208. Screen-sharing provider 2208 may instantiate a screen-sharing session between user interface UI and AI chatbot 2202. screen share video streamer 2210 may stream real-time video to AI chatbot 2202. Architecture 2200 may feed the video to frame-capturing converter 2212. Frame-capturing converter 2212 may capture still frames, such as frames 1-N, from the video. Frame-capturing converter 2212 may provide the frames to tile segmenting converter 2214. Tile segmenting converter 2214 may segment the frames into tiles. Tile segmenting converter 2214 may provide the tiles to UI elements detector 2216. UI elements detector 2216 may identify elements of the tiles. UI elements detector 2216 may compare the elements of the tiles to know UI elements in enterprise apps elements model 2218, which may include models UI elements from the enterprise's web pages. Apps elements model may include a computer vision model that is trained on labeled UI elements from enterprisecorp.com domain.

Architecture 2200 may feed the video to cursor/keyboard detector 2220.

Cursor/keyboard detector 2220 may identify cursor positions and keyboard input in user interface UI. Cursor/keyboard detector 2220 may provide the cursor positions and keyboard input to UI elements detector 2216. UI elements detector 2216 may use the cursor positions and keyboard inputs to help match output from tile segmenting converter 2214 to modeled UI elements in enterprise apps elements model 2218. UI elements detector 2216 may subtract the cursor and keyboard inputs from output from tile segmenting converter 2214 to help match output from tile segmenting converter 2214 to modeled UI elements in enterprise apps elements model 2218.

UI elements detector 2216 may feed detected UI elements to screen context detector 2222. UI elements detector 2216 may feed detected cursor and keyboard inputs to screen context detector 2222. Screen context detector 2222 may, in conjunction with screen context model 2223, determine an apparent intention of user U based on the detected cursor and keyboard inputs along with the detected UI elements.

User action validator 2224 may compare the apparent intent to the request intent. User action validator 2224 may interact with intent workflow repository 2226, which may include a library of intents associated with request intents and apparent intents. User action validator may determine that a user action is inconsistent with the request intent. User action validator may make the determination, in real time, for each user action identified by cursor/keyboard detector 2220. User action validator 2224 may make the determination, in real time, for each apparent intent determined by screen context model 2223. User action validator 2224 may generate an error message that defines the discrepancy between a user action and an assistive user action that is required to compensate for a user action that is not consistent with the request intent.

Annotations provider 2228 may generate assistive information. The assistive information may be provided to user interface UI to assist a user such as user U in navigating to interactive UI elements that are consistent with the request intent. Annotations provider 2228 may receive detected UI elements from UI elements detector 2216. Annotations provider 2228 may generate web resource navigation instructions based on one or more determinations from user action validator 2224. Annotations provider 2228 may generate web resource navigation instructions based on an error code generated by user action validator 2224.

The web resource navigation instructions may correspond to a sequence of actions that user U may follow to navigate from a current web page, position on the web page, or user element to a new web page, position on the web page, or user element that is more consistent with the request intent.

Annotations provider 2228 may incorporate into the assistive information, and into formatting and layout of the assistive information, detected UI elements, and coordinates thereof, with the web resource navigation instructions to provide annotation or annotations to move user U to a web resource that is consistent with the request intent. The layout may span across one or more web pages. The layout may include one or more overlays that are overlaid over web pages that are displayed in user interface UI. Annotations provider 2228 may provide the overlay or overlays to screen share provider for display in the screen-sharing session to user interface UI.

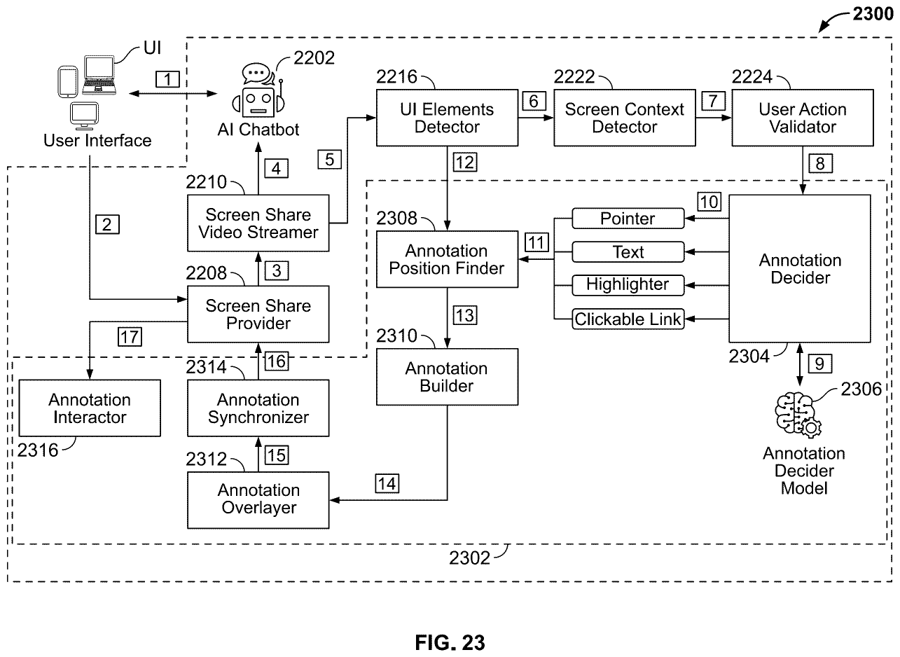

FIG. 23 shows illustrative architecture 2300. Architecture 2300 may include annotations provider 2302. Annotations provider 2302 may have one or more features in common with annotations provider 2224. Architecture 230 may include one or more of components 2202, 2216, 2222, 2224, 2208 and 2210.

Annotations provider 2302 may include annotation decider 2304, annotation decider model 2306, annotation position finder 2308, annotation builder 2310, annotation overlayer 2312, annotation synchronizer 2314 and annotation interactor 2316.

Annotation decider 2304 may receive a determination from user action validator 2224. Annotation decider 2304 may choose an assistive information format to present to user interface UI. The assistive information format may include a pointer, text, highlighting, a clickable link or any other suitable format. Annotation decider 2304 may select the format based on a user's (such as user U) historical behavior, the user's level of experience using on-line user access system 102, the user's personal profile or preferences, the size of user interface UI (e.g., mobile phone, tablet, laptop or desktop), or any other suitable information. Annotation decider 2304 may feed the format selection to annotation position finder 2308. For example, an inexperienced user may benefit from an arrow showing a trajectory, whereas a more experienced user may need only highlighting of a targeted element.

Annotation position finder 2308 may receive from UI elements detector 2216 identifiers, positions and layout profiles (height, width, colors, interactive features (hyperlinks, drop down lists, radio buttons, etc.), font sizes, etc.) of user elements present in user interface UI. annotation position finder 2308 may identify which of several UI elements in a tile is to be the target of the assistive information.

Annotation builder 2310 may create an assistive UI element to be overlaid on the web page that user U is viewing. The assistive UI element may include the format. The assistive UI element may include directive information to direct user U to perform a user action that is consistent with the request intent. The assistive UI element may request and receive from user U content or information that user U previously omitted or provided incorrectly.

Annotation overlayer 2312 may generate markup code or a web page that expresses the overlay of the assistive information on user U's current web page. The markup code may be inserted into the current web page markup code. The markup code may be written into markup code that defines a substitute web page that is presented to user U instead of user U's current web page. Annotation overlayer 2312 may feed the markup code or web page to annotation synchronizer 2314.

Annotation synchronizer 2314 may overlay assistive information defined by the markup code into user U's view of the screen-sharing session. The assistive information may be superimposed on an image of user U's view of the screen-sharing session without incorporating the assistive markup code into the markup code underlying user U's view of the screen-sharing session.

Annotation synchronizer 2314 may integrate the markup code into user U's view of the screen-sharing session. Markup code may be provided to user U's browser.

Annotation interactor 2316 may provide feedback to robotic user assistance system 104 to validate synchronization of the assistive information with the user U's view of window 111.

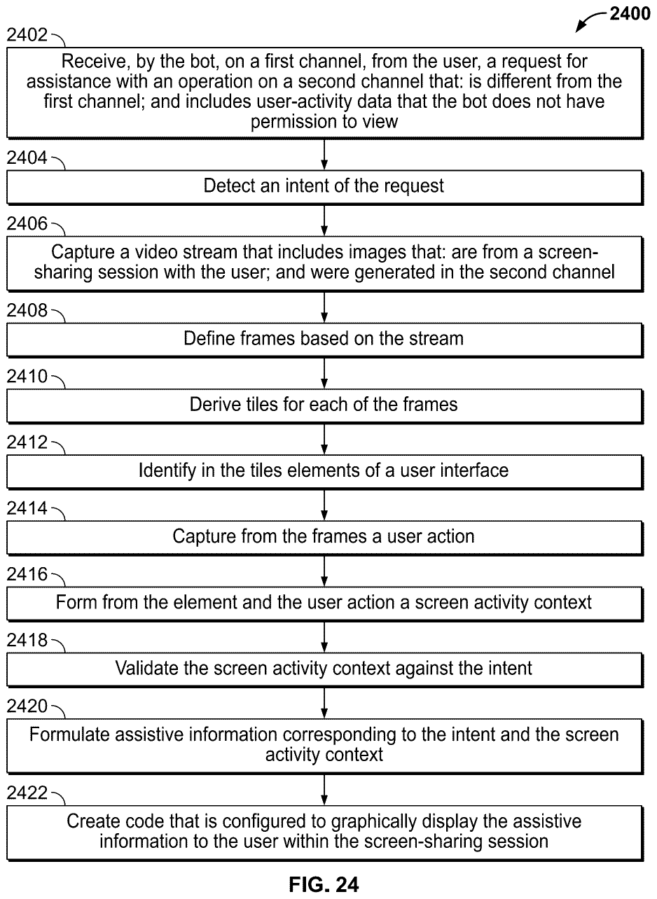

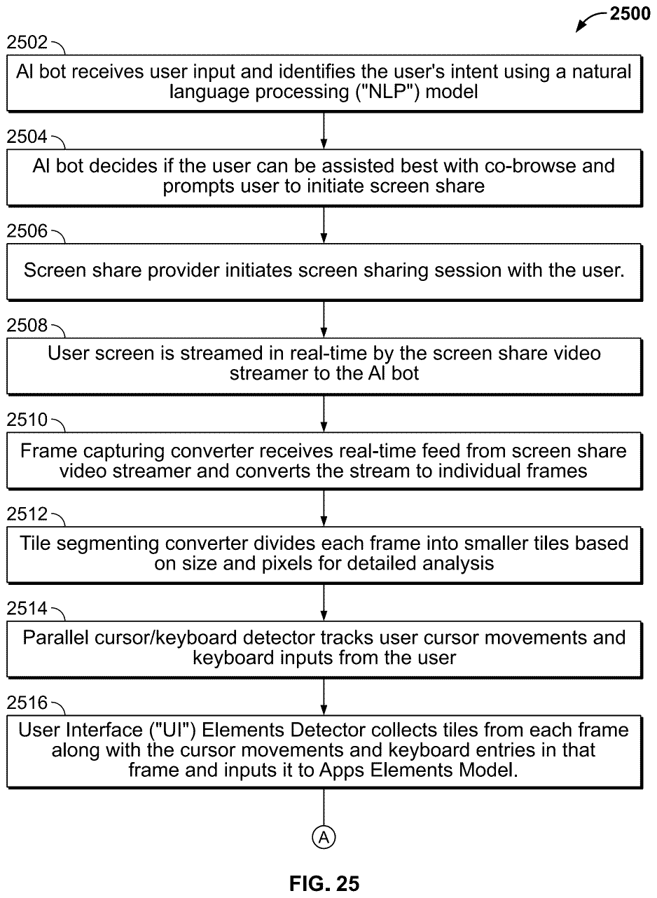

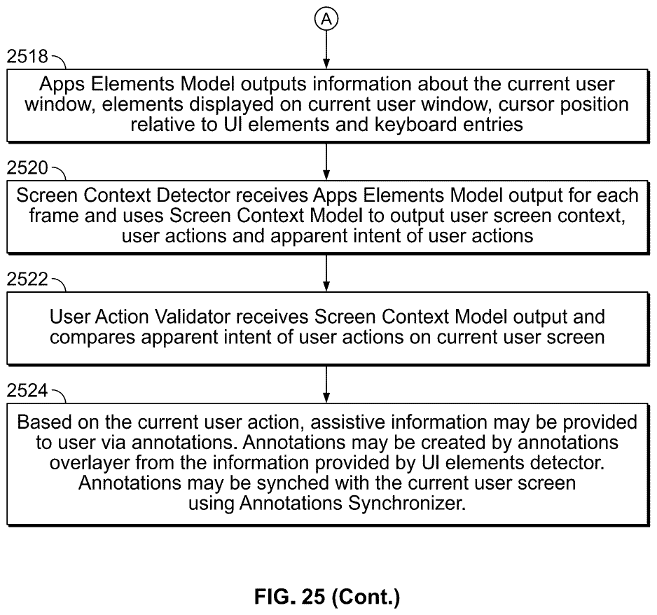

FIGS. 24 and 25 shows steps of illustrative processes. Some or all of the steps may be performed in the context of one or both of architectures 100 and 2200. The steps will be described as being performed by “the system,” which may include apparatus, methods and devices shown and described in one or more of FIGS. 1-23.

FIG. 24 shows steps of illustrative process 2400.

At step 2402, the system may receive, by the bot, on a first channel, from the user, a request for assistance with an operation on a second channel that: is different from the first channel; and includes user-activity data that the bot does not have permission to view.

At step 2404, the system may detect an intent of the request (a “request intent”).

At step 2406, the system may capture a video stream that includes images that: are from a screen-sharing session with the user; and were generated in the second channel.

At step 2408, the system may define frames based on the stream.

At step 2410, the system may derive tiles for each of the frames.

At step 2412, the system may identify in the tiles elements of a user interface.

At step 2414, the system may capture from the frames a user action.

At step 2416, the system may form from the element and the user action a screen activity context. The screen activity context may include an “apparent” request.

At step 2418, the system may validate the screen activity context against the intent. The validation may include generating an error message that defines a discrepancy between the request intent and the apparent intent.

At step 2420, the system may formulate assistive information corresponding to the error message.

At step 2422, the system may create code that is configured to graphically display the assistive information to the user withing the screen-sharing session.

FIG. 25 shows steps of illustrative process 2500.

At step 2502, the system may receive a user request and identify the user's intent using a natural language processing (“NLP”) model.

At step 2504, the system may decide if the user can be assisted best with co-browse and may prompt user to initiate screen share.

At step 2506, the system may, via a screen share provider, initiate a screen sharing session with the user.

At step 2508, the system may User screen is streamed in real-time by the screen share video streamer to the AI bot.

At step 2510, the system may receive real-time feed from the screen share video streamer and convert the stream to individual frames.

At step 2512, the system may divide each frame into tiles based on size and pixels for detailed analysis.

At step 2514, the system may track user cursor movements and keyboard inputs from the user.

At step 2516, the system may collect tiles from each frame along with the cursor movements and keyboard entries in that frame feed them into an Apps Elements Model for identification of the UI elements in the tiles. The Apps Elements Model may include a computer vision model which is trained on labeled UI elements from enterprisecorp.com domain.

At step 2118, the system may output, from the Apps Elements Model, information about the current user window, elements displayed on current user window, cursor position relative to UI elements and keyboard entries.

At step 2120, the system may receive, by a screen context model, Apps Elements Model output for each frame, and use the Screen Context Model to output user screen context, user actions and apparent intent of user actions.

At step 2122, the system may receive, at a User Action Validator, Screen Context Model output, and compare apparent intent of user actions on current user screen to an intent of the user request.

At step 2124, the system may provide, based on the current user action, assistive information to the user via annotations. Annotations may be created by an annotations overlayer from the information provided by UI elements detector. Annotations may be synched with the current user screen using an Annotations Synchronizer.

Thus, apparatus and methods providing a co-browsing session between an artificial intelligence (“AI”)-equipped customer assistance digital robot (“bot”) and a user of an enterprise information system portal are provided. Persons skilled in the art will appreciate that the present invention can be practiced by other than the described embodiments, which are presented for purposes of illustration rather than of limitation.

1. A method for providing a co-browsing session between an artificial intelligence (“AI”)-equipped customer assistance digital robot (“bot”) and a user of an enterprise information system portal, the method comprising:
receiving, by the bot, on a first channel that is accessible by the user from the portal, from the user, a request for assistance performing an operation on a working web page that is accessible by the user via the portal from a second channel that is:
different from the first channel; and
in communication with a user-activity monitor that is configured to collect and serve user-activity data that the bot does not have permission to view;
detecting an intent of the request;
capturing a video stream that includes images that:
are from a screen-sharing session with the user; and
were generated in the second channel;
defining frames based on the stream;
deriving a tile for each of the frames;
identifying in the tile derived for each of the frames an element of a user interface;
capturing from the frames a user action;
forming from:
the element identified in each tile; and
the user action a screen activity context;
validating the screen activity context against the intent;
formulating assistive information corresponding to:
the intent; and
the screen activity context; and
creating code that is configured to graphically display the assistive information to the user within the screen-sharing session.

2. The method of claim 1 wherein the identifying in each tile includes matching the element to elements that are known to be included in the second channel.

3. The method of claim 1 wherein the user action corresponds to a cursor position.

4. The method of claim 1 wherein the user action corresponds to a keyboard entry.

5. The method of claim 1 wherein the user action corresponds to a mouse click.

6. The method of claim 1 wherein the assistive information includes:
a directive; and
a format.

7. The method of claim 6 further comprising selecting the format from the group consisting of:
a pointer;
text;
highlighting; and
a clickable link.

8. The method of claim 1 further comprising, when the frames include a spatial coordinate schema that corresponds to:
the frame; and
a window in which the user operates during the screen-sharing, identifying coordinates of the spatial coordinate schema at which to display the assistive information.

9. The method of claim 8 wherein the special coordinate system is referenced to a point in a frame.

10. The method of claim 8 wherein the special coordinate system is referenced to a point in each tile.

11. Apparatus for providing a co-browsing session between an artificial intelligence (“AI”)-equipped customer assistance digital robot (“bot”) and a user of an enterprise information system portal, the apparatus comprising:
a robotic user assistance system that is configured to:
communicate with a user that is in communication with an on-line user access system; and
an information services system that is configured to provide a screen-sharing session with the user;
receive on a first channel, from the user, a request for assistance performing an operation on a working web page that is accessible by the user via the portal from a second channel that is:
different from the first channel; and
in communication with a user-activity monitor that is configured to collect and serve user-activity data that the robotic user assistance system does not have permission to view;
detect an intent of the request;
capture a video stream that includes images that:
are from the screen-sharing session with the user; and
were generated in the second channel;
define frames based on the stream;
derive a tile for each of the frames;
identify in the tile derived for each of the frames an element of a user interface;
capture from the frames a user action;
form from:
the element identified in each tile; and
the user action a screen activity context;
validate the screen activity context against the intent;
formulate assistive information corresponding to:
the intent; and
the screen activity context; and
create code that is configured to graphically display the assistive information to the user within the screen-sharing session; and
identify in the frames coordinates of a spatial coordinate schema at which to display the assistive information in a window in which the user operates during the screen-sharing.

12. The apparatus of claim 11 wherein the robotic user assistance system is further configured to determine that the user action is consistent with the intent.

13. The apparatus of claim 11 wherein the coordinates correspond to a current user cursor position.

14. The apparatus of claim 11 wherein the robotic user assistance system is further configured to determine that the user action is not consistent with the intent.

15. The apparatus of claim 14 wherein:
the element is a first element; and
the robotic user assistance system is configured to determine that a second element better matches the intent than does the first element.

16. The apparatus of claim 15 wherein the coordinates correspond to an assistive user cursor position.

17. The apparatus of claim 16 wherein the assistive information includes:
markup language that is designated for the second element; and
coordinates corresponding to the second element.

18. The apparatus of claim 14 wherein:
the user action corresponds to first content; and
the robotic user assistance system is configured to determine that a second content better matches the intent than does the first content.

19. The apparatus of claim 18 wherein the assistive information includes:
markup language that is configured to display the second content; and
coordinates that correspond to the element.

20. The apparatus of claim 18 wherein the coordinates correspond to a current user cursor position.
